(19) United States
(12) Patent Application Publication
(10) Pub. No.: US 2015/0007025 A1
(43) Pub. Date: Jan. 1, 2015

(54) Apparatus

(71) Applicant: Nokia Corporation, Espoo (FI)

(72) Inventors: Antti Heikki Tapio Sassi, Pirkkala (FI); Erkko Juhana ANTTILA, Espoo (FI)

(21) Appl. No.: 14/319,266

(22) Filed: Jun. 30, 2014

(30) Foreign Application Priority Data
Jul. 1, 2013 (GB) 1311764.3

(51) Int. Cl. G06F 3/01; G06F 3/0488; H04M 1/725; G06F 3/0484

(52) U.S. Cl. CPC G06F 3/016; G06F 3/04842; G06F 3/04886; H04M 1/72519
USPC 715/702

(57) ABSTRACT

An apparatus comprising: at least one sensor means for determining at least one proximate object; means for determining at least one parameter associated with the at least one proximate object; and means for generating by ultrasound at least one tactile effect to the determined at least one proximate object based on the at least one parameter.

### FIELD

The present invention relates to a providing tactile functionality. The invention further relates to, but is not limited to, ultrasound transducers providing tactile functionality for use in mobile devices.

### BACKGROUND

Many portable devices, for example mobile telephones, are equipped with a display such as a glass or plastic display window for providing information to the user. Furthermore such display windows are now commonly used as touch sensitive inputs. The use of a touch sensitive input with the display has the advantage over a mechanical keypad in that the display may be configured to show a range of different inputs depending on the operating mode of the device. For example, in a first mode of operation the display may be enabled to enter a phone number by displaying a simple numeric keypad arrangement and in a second mode the display may be enabled for text input by displaying an alphanumeric display configuration such as a simulated Qwerty keyboard display arrangement.

However touching a “button” on a virtual keyboard is more difficult than a real button. The user sometimes has to visually check whether the device or apparatus has accepted the specific input. In some cases the apparatus can provide a visual feedback and an audible feedback. In some further devices the audible feedback is augmented with a vibrating motor used to provide a haptic feedback so the user knows that the device has accepted the input.

Pure audio feedback has the disadvantage that it is audible by people around you and therefore able to distract or cause a nuisance especially on public transport. Furthermore pure audio feedback has the disadvantage that it can emulate reality only partially by providing the audible portion of the feedback but not a tactile portion of the feedback.

Using a vibra to implement haptic feedback furthermore is unable to provide suitable haptic feedback in the circumstances where the input is not a contact input. A known type of input is that of ‘floating touch’ inputs where the finger or other pointing device is located above and not in direct contact with the display or other touch sensitive sensor. By definition such ‘floating touch’ inputs cannot experience the effect generated by the vibra when moving the device to respond to the input.

### SUMMARY

According to an aspect, there is provided a method comprising: determining at least one proximate object by at least one sensor; determining at least one parameter associated with the at least one proximate object; and generating using at least one ultrasound transducer at least one tactile effect to the determined at least one proximate object based on the at least one parameter.

The method may further comprise: determining at least one interactive user interface element; determining the at least one parameter is associated with the at least one interactive user interface element; and generating at least one tactile effect signal to be output to the at least one ultrasound transducer so to generate the tactile effect based on the at least one parameter being associated with the at least one interactive user interface element.

The method may further comprise controlling the at least one ultrasound transducer to generate at least one ultrasound wave based on the at least one interactive user interface element and the at least one parameter.

Determining the at least one proximate object by the at least one sensor may comprise determining the at least one proximate object by a display comprising the at least one sensor.

The method may further comprise generating using the display at least one visual effect based on the at least one parameter.

Determining the at least one parameter associated with the at least one proximate object may comprise determining at least one of: a number of the at least one proximate objects; a location of the at least one proximate object; a direction of the at least one proximate object; a speed of the at least one proximate object; an angle of the at least one proximate object; and a duration of the at least one proximate object.

Generating using at least one ultrasound transducer the at least one tactile effect to the determined at least one proximate object based on the at least one parameter may comprise generating at least one of: a tactile effect pressure wave envelope to the determined at least one proximate object based on the at least one parameter; a tactile effect pressure wave amplitude to the determined at least one proximate object based on the at least one parameter; a tactile effect pressure wave duration to the determined at least one proximate object based on the at least one parameter; and a tactile effect pressure wave direction to the determined at least one proximate object based on the at least one parameter.

Determining the at least one proximate object by the at least one sensor may comprises at least one of: determining the at least one proximate object by at least one capacitive sensor; determining the at least one proximate object by at least one non-contact sensor; determining the at least one proximate object by at least one imaging sensor; determining the at least one proximate object by at least one hover sensor; and determining the at least one proximate object by at least one fogale sensor.

Generating using the at least one ultrasound transducer the at least one tactile effect to the determined at least one proximate object based on the at least one parameter may comprise controlling the at least one ultrasound transducer to generate the at least one ultrasound wave based on the at least one parameter.

According to a second aspect there is provided an apparatus comprising: at least one sensor means for determining at least one proximate object; means for determining at least one parameter associated with the at least one proximate object; and means for generating by ultrasound at least one tactile effect to the determined at least one proximate object based on the at least one parameter.

The apparatus may further comprise: means for determining at least one interactive user interface element; means for determining the at least one parameter is associated with the at least one interactive user interface element; and means for generating at least one tactile effect signal to be output to at least one ultrasound transducer means so to generate the tactile effect based on the at least one parameter being associated with the at least one interactive user interface element.

The apparatus may further comprise means for controlling the at least one ultrasound transducer to generate at least one ultrasound wave based on the at least one interactive user interface element and the at least one parameter.

The at least one sensor means for determining at least one proximate object may comprise display means for determining the at least one proximate object.

The apparatus may further comprise means for generating on the display means at least one visual effect based on the at least one parameter.

The means for determining at least one parameter associated with the at least one proximate object may comprise at least one of: means for determining the number of the at least one proximate objects; means for determining the location of the at least one proximate object; means for determining the direction of the at least one proximate object; means for determining the speed of the at least one proximate object; means for determining the angle of the at least one proximate object; and means for determining the duration of the at least one proximate object.

The means for generating by ultrasound at least one tactile effect to the determined at least one proximate object based on the at least one parameter may comprise at least one of: means for generating a tactile effect pressure wave envelope to the determined at least one proximate object based on the at least one parameter; means for generating a tactile effect pressure wave amplitude to the determined at least one proximate object based on the at least one parameter; means for generating a tactile effect pressure wave duration to the determined at least one proximate object based on the at least one parameter; and means for generating a tactile effect pressure wave direction to the determined at least one proximate object based on the at least one parameter.

The at least one sensor means for determining the at least one proximate object may comprise at least one of: at least one capacitive sensor means for determining the at least one proximate object; at least one non-contact sensor means for determining the at least one proximate object; at least one imaging sensor means for determining the at least one proximate object; at least one hover sensor means for determining the at least one proximate object; and at least one fogale sensor means for determining the at least one proximate object.

The means for generating by ultrasound at least one tactile effect to the determined at least one proximate object based on the at least one parameter comprises means for controlling at least one ultrasound transducer to generate at least one ultrasound wave based on the at least one parameter.

According to a third aspect there is provided an apparatus comprising: at least one sensor configured to determine at least one proximate object; a parameter determiner configured to determine at least one parameter associated with the at least one proximate object; and at least one ultrasound generator configured to generate at least one tactile effect to the determined at least one proximate object based on the at least one parameter.

The apparatus may further comprise: a user interface determiner configured to determine at least one interactive user interface element; at least one interaction determiner configured to determine the at least one parameter is associated with the at least one interactive user interface element; and a tactile effect generator configured to generate at least one tactile effect signal to be output to at least one ultrasound generator so to generate the tactile effect based on the at least one parameter being associated with the at least one interactive user interface element.

The apparatus may further comprise an ultrasound transducer driver configured to control the at least one ultrasound generator to generate at least one ultrasound wave based on the at least one interactive user interface element and the at least one parameter.

The at least one sensor may comprise a display configured to determine the at least one proximate object.

The apparatus may further comprise a display UI generator configured to generate on a display at least one visual effect based on the at least one parameter.

The parameter determiner may be configured to determine at least one of: a number of the at least one proximate objects; a location of the at least one proximate object; a direction of the at least one proximate object; a speed of the at least one proximate object; an angle of the at least one proximate object; and a duration of the at least one proximate object.

The ultrasound generator may be configured to generate at least one of: a tactile effect pressure wave envelope to the determined at least one proximate object based on the at least one parameter; a tactile effect pressure wave amplitude to the determined at least one proximate object based on the at least one parameter; a tactile effect pressure wave duration to the determined at least one proximate object based on the at least one parameter; and a tactile effect pressure wave direction to the determined at least one proximate object based on the at least one parameter.

The at least one sensor may comprise at least one of: at least one capacitive sensor; at least one non-contact sensor; at least one imaging sensor; at least one hover sensor; and at least one fogale sensor.

The ultrasound generator may comprise an ultrasound controller configured to control at least one ultrasound transducer to generate at least one ultrasound wave based on the at least one parameter.

According to a fourth aspect there is provided an apparatus comprising at least one processor and at least one memory including computer code for one or more programs, the at least one memory and the computer code configured to with the at least one processor cause the apparatus to at least: determine at least one proximate object by at least one sensor; determine at least one parameter associated with the at least one proximate object; and generate using at least one ultrasound transducer at least one tactile effect to the determined at least one proximate object at the location of the at least one proximate object based on the at least one parameter.

The apparatus may be further caused to: determine at least one interactive user interface element; determine the at least one parameter is associated with the at least one interactive user interface element; and generate at least one tactile effect signal to be output to the at least one ultrasound transducer so to generate the tactile effect based on the at least one parameter being associated with the at least one interactive user interface element.

The apparatus may be further caused to control the at least one ultrasound transducer to generate at least one ultrasound wave based on the at least one interactive user interface element and the at least one parameter.

Determining at least one proximate object by the at least one sensor may cause the apparatus to determine at least one proximate object by a display comprising the at least one sensor.

The apparatus may be further caused to generate using the display at least one visual effect based on the at least one parameter.

Determining at least one parameter associated with the at least one proximate object may cause the apparatus to determine at least one of: a number of the at least one proximate objects; a location of the at least one proximate object; a direction of the at least one proximate object; a speed of the at least one proximate object; an angle of the at least one proximate object; and a duration of the at least one proximate object.

Generating using at least one ultrasound transducer at least one tactile effect to the determined at least one proximate object at the location of the at least one proximate object based on the at least one parameter may cause the apparatus to generate at least one of: a tactile effect pressure wave envelope to the determined at least one proximate object based on the at least one parameter; a tactile effect pressure wave amplitude to the determined at least one proximate object at the location of the at least one proximate object based on the at least one parameter; a tactile effect pressure wave duration to the determined at least one proximate object at the location of the at least one proximate object based on the at least one parameter; and a tactile effect pressure wave direction to the determined at least one proximate object at the location of the at least one proximate object based on the at least one parameter.

Determining the at least one proximate object by at least one sensor comprises at least one of: determining the at least one proximate object by at least one capacitive sensor; determining the at least one proximate object by at least one non-contact sensor; determining the at least one proximate object by at least one imaging sensor; determining the at least one proximate object by at least one hover sensor; and determining the at least one proximate object by at least one fogale sensor.

Generating using at least one ultrasound transducer at least one tactile effect to the determined at least one proximate object at the location of the at least one proximate object based on the at least one parameter may cause the apparatus to control the at least one ultrasound transducer to generate at least one ultrasound wave based on the at least one parameter.

According to a fifth aspect there is provided an apparatus comprising: at least one display; at least one processor; at least one ultrasound actuator; at least one transceiver; at least one sensor configured to determine at least one proximate object; a parameter determiner configured to determine at least one parameter associated with the at least one proximate object; and at least one ultrasound generator configured to generate with the at least one ultrasound actuator at least one tactile effect to the determined at least one proximate object based on the at least one parameter.

A computer program product stored on a medium may cause an apparatus to perform the method as described herein.

An electronic device may comprise apparatus as described herein.

A chipset may comprise apparatus as described herein.

### SUMMARY OF FIGURES

For better understanding of the present invention, reference will now be made by way of example to the accompanying drawings in which:

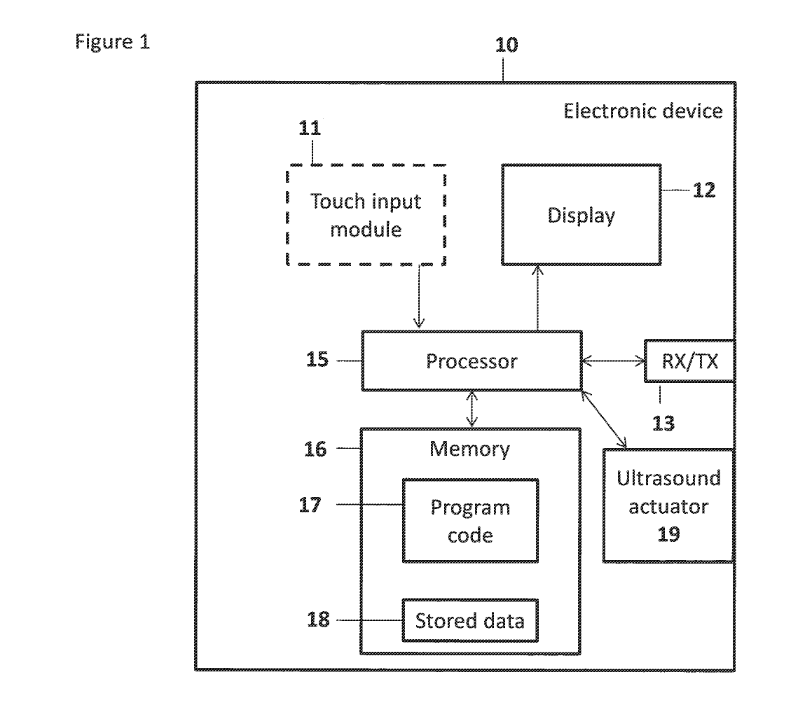

a. FIG. 1 shows schematically an apparatus suitable for employing some embodiments;

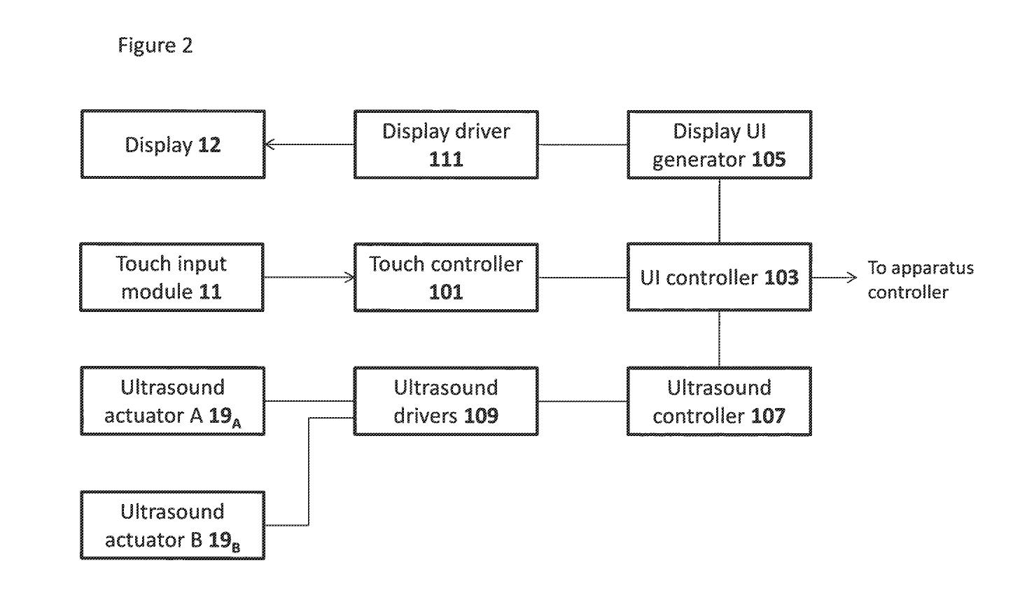

b. FIG. 2 shows schematically an example tactile display device according to some embodiments;

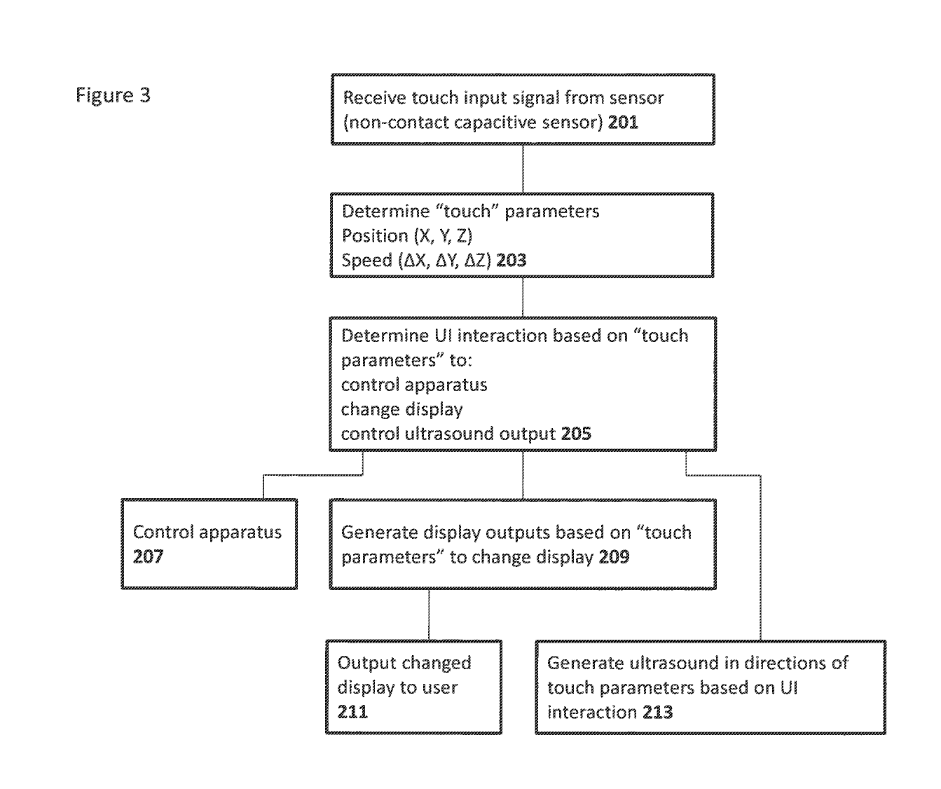

c. FIG. 3 shows schematically the operation of the example tactile display device as shown in FIG. 2;

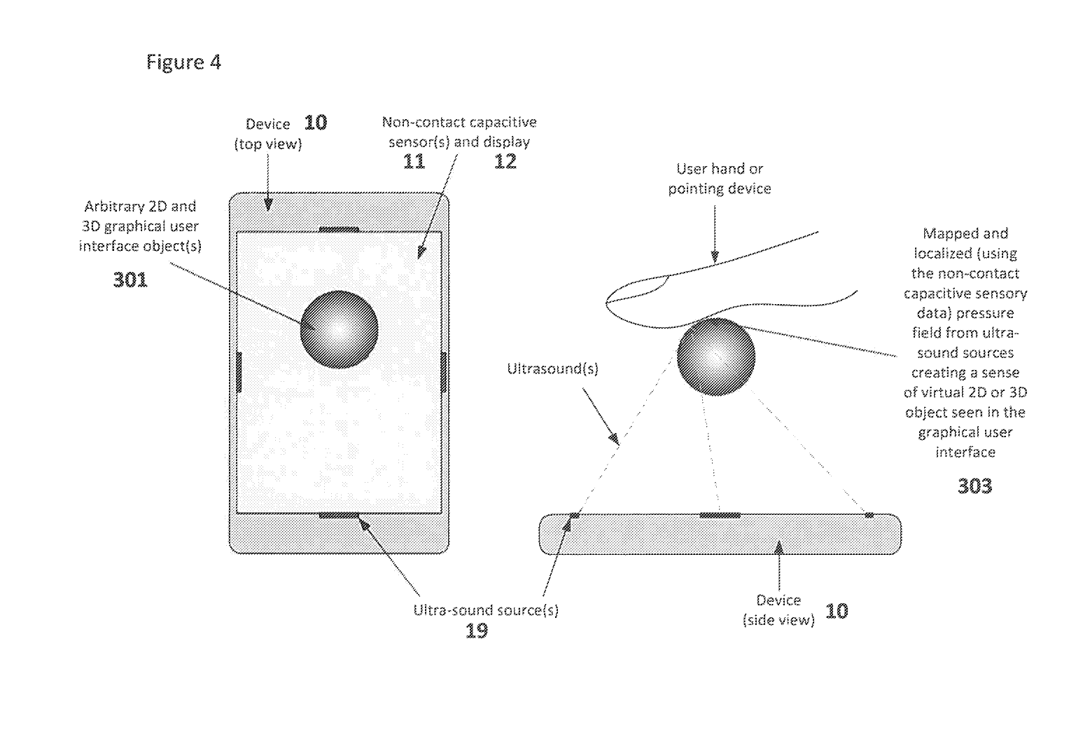

d. FIG. 4 shows schematically views of the example tactile display device in operation according to some embodiments;

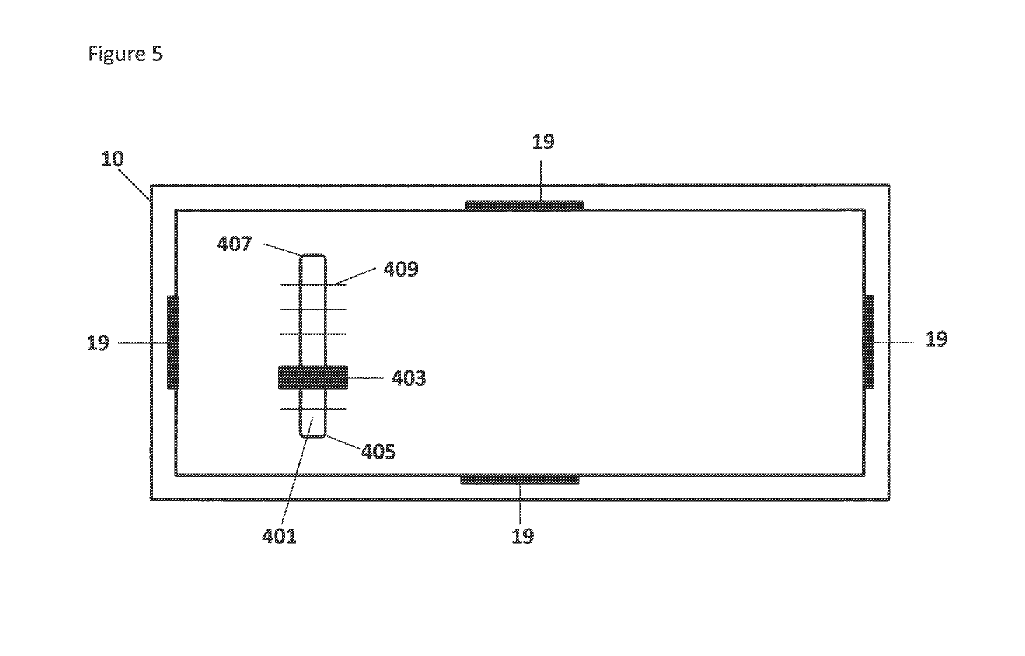

e. FIG. 5 shows schematically an example slider display suitable for the tactile display device according to some embodiments;

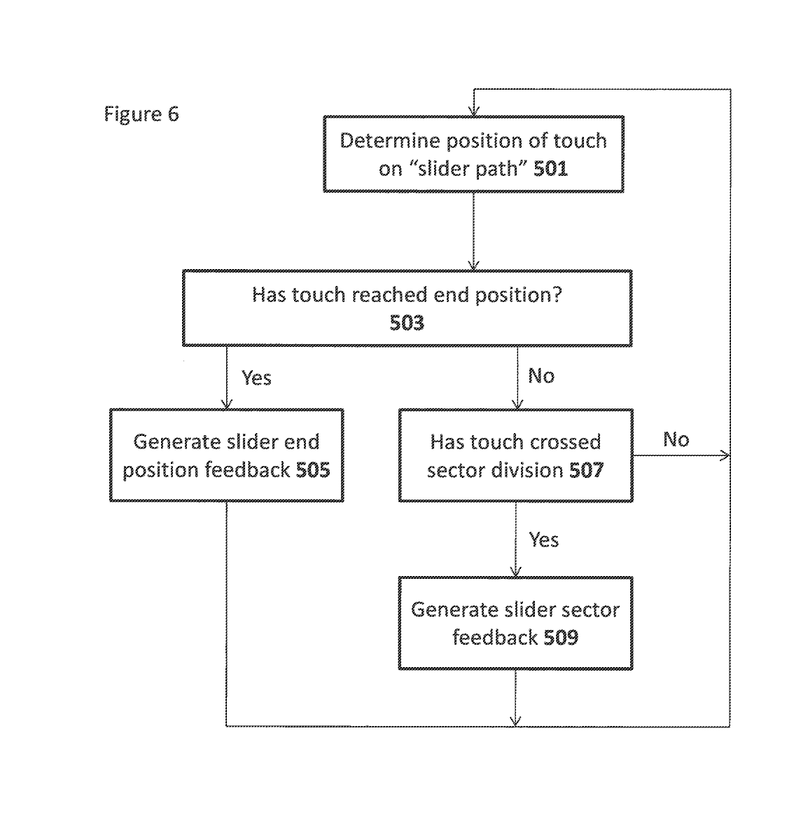

f. FIG. 6 shows schematically a flow diagram of the operation of the tactile display device with respect to a simulated slider effect according to some embodiments; and

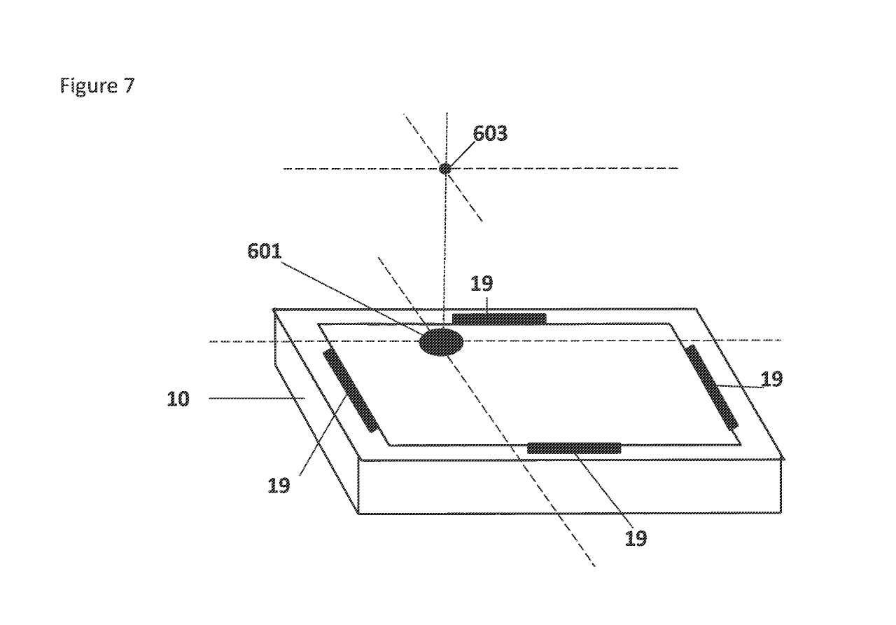

g. FIGS. 7 to 9 show example virtual joystick operations on the example tactile display device according to some embodiments.

### DESCRIPTION OF EXAMPLE EMBODIMENTS

The application describes apparatus and methods capable of generating, encoding, storing, transmitting and outputting tactile outputs from a device suitable for detecting non-contact inputs, also known as floating touch inputs.

With respect to FIG. 1 a schematic block diagram of an example electronic device 10 or apparatus on which embodiments of the application can be implemented. The apparatus 10 is such embodiments configured to provide improved tactile and acoustic wave generation.

The apparatus 10 is in some embodiments a mobile terminal, mobile phone or user equipment for operation in a wireless communication system. In other embodiments, the apparatus is any suitable electronic device configured to provide an image display, such as for example a digital camera, a portable audio player (mp3 player), a portable video player (mp4 player). In other embodiments the apparatus can be any suitable electronic device with touch interface (which may or may not display information) such as a touch-screen or touch-pad configured to provide feedback when the touch-screen or touch-pad is touched. For example in some embodiments the touch-pad can be a touch-sensitive keypad which can in some embodiments have no markings on it and in other embodiments have physical markings or designations on the front window. An example of such a touch sensor can be a touch sensitive user interface to replace keypads in automatic teller machines (ATM) that does not require a screen mounted underneath the front window projecting a display. The user can in such embodiments be notified of where to touch by a physical identifier—such as a raised profile, or a printed layer which can be illuminated by a light guide.

The apparatus 10 comprises a touch input module or user interface 11, which is linked to a processor 15. The processor 15 is further linked to a display 12. The processor 15 is further linked to a transceiver (TX/RX) 13 and to a memory 16.

In some embodiments, the touch input module 11 and/or the display 12 are separate or separable from the electronic device and the processor receives signals from the touch input module 11 and/or transmits and signals to the display 12 via the transceiver 13 or another suitable interface. Furthermore in some embodiments the touch input module 11 and display 12 are parts of the same component. In such embodiments the touch interface module 11 and display 12 can be referred to as the display part or touch display part.

The processor 15 can in some embodiments be configured to execute various program codes. The implemented program codes, in some embodiments can comprise such routines as touch processing, input simulation, or tactile effect simulation code where the touch input module inputs are detected and processed, effect feedback signal generation where electrical signals are generated which when passed to a transducer can generate tactile or haptic feedback to the user of the apparatus, or actuator processing configured to generate an actuator signal for driving an actuator. The implemented program codes can in some embodiments be stored for example in the memory 16 and specifically within a program code section 17 of the memory 16 for retrieval by the processor 15 whenever needed. The memory 15 in some embodiments can further provide a section 18 for storing data, for example data that has been processed in accordance with the application, for example pseudo-audio signal data.

The touch input module 11 can in some embodiments implement any suitable touch screen interface technology. For example in some embodiments the touch screen interface can comprise a capacitive sensor configured to be sensitive to the presence of a finger above or on the touch screen interface. The capacitive sensor can comprise an insulator (for example glass or plastic), coated with a transparent conductor (for example indium tin oxide—ITO). As the human body is also a conductor, touching the surface of the screen results in a distortion of the local electrostatic field, measurable as a change in capacitance. Any suitable technology may be used to determine the location of the touch. The location can be passed to the processor which may calculate how the user's touch relates to the device. The insulator protects the conductive layer from dirt, dust or residue from the finger.

In some other embodiments the touch input module can further determine a touch using technologies such as visual detection for example a camera either located below the surface or over the surface detecting the position of the finger or touching object, projected capacitance detection, infra-red detection, surface acoustic wave detection, dispersive signal technology, and acoustic pulse recognition. In some embodiments it would be understood that ‘touch’ can be defined by both physical contact and ‘hover touch’ where there is no physical contact with the sensor but the object located in close proximity with the sensor has an effect on the sensor.

The apparatus 10 can in some embodiments be capable of implementing the processing techniques at least partially in hardware, in other words the processing carried out by the processor 15 may be implemented at least partially in hardware without the need of software or firmware to operate the hardware.

The transceiver 13 in some embodiments enables communication with other electronic devices, for example in some embodiments via a wireless communication network.

The display 12 may comprise any suitable display technology. For example the display element can be located below the touch input module and project an image through the touch input module to be viewed by the user. The display 12 can employ any suitable display technology such as liquid crystal display (LCD), light emitting diodes (LED), organic light emitting diodes (OLED), plasma display cells, Field emission display (FED), surface-conduction electron-emitter displays (SED), and Electophoretic displays (also known as electronic paper, e-paper or electronic ink displays). In some embodiments the display 12 employs one of the display technologies projected using a light guide to the display window. As described herein the display 12 in some embodiments can be implemented as a physical fixed display. For example the display can be a physical decal or transfer on the front window. In some other embodiments the display can be located on a physically different level from the rest of the surface, such a raised or recessed marking on the front window. In some other embodiments the display can be a printed layer illuminated by a light guide under the front window

In some embodiments the apparatus comprises at least one ultrasound actuator 19 or transducer configured to generate acoustical waves with a frequency higher than the human hearing range.

This embodiments as described herein present apparatus and methods to generate 2D and 3D tactile feedback in non-contact capacitive user interface using a known method to create tactile feedback using ultrasound.

In such embodiments as described herein the non-contact capacitive user interface can be configured to accurately detect the user input, such as the user's finger or hand or other suitable pointing device, the location, form and shape, and distance and using this data control an array of ultrasound sources to create tactile feedback, for example boundaries of a virtual shape that can be sensed by the user.

Thus the concept as described in the embodiments herein is to use the positional, form and shape, information derived by non-contact sensor such as a capacitive user interface (touch interface) to steer and control an array of ultrasound sources to create acoustic radiation pressure field that is sensed as tactile feedback, or a 3D virtual object, without the need to touch the user interface. The tactile feedback may change based on position, form and shape, of the hand or pointing device.

Thus in such embodiments it can be possible to implement simulated experiences using the ultrasound sources and in some embodiments the display (to provide a visual response output) and ultrasound sources (as a tactile response output) and audio outputs (to provide an audio response output). In some embodiments the simulated experiences are simulations of mechanical buttons, sliders, and knobs and dials effectively using tactile effects. Furthermore these tactile effects can be employed for any suitable haptic feedback wherein an effect is associated with a suitable display input characteristic. For example the pressure points on a simulated mechanical button, mechanical slider or rotational knob or dial.

With respect to FIG. 2 a first example tactile display device according to some embodiments is shown. Furthermore with respect to FIG. 3 the operation of the example tactile display device as shown in FIG. 2 is described in further detail.

In some embodiments the tactile display device comprises a touch controller 101. The touch controller 101 can be configured to receive the output of the touch input module 11 (a capacitive non-touch sensor).

The operation of receiving the touch input signal from the sensor such as the non-contact capacitive sensor is shown in FIG. 3 by step 201.

The touch controller 101 can then be configured to determine from the touch input signal suitable touch parameters. The touch parameters can for example indicate the number of touch objects, the shape of touch objects, the position of the touch objects, and the speed of the touch objects.

The operation of determining the touch parameters is shown in FIG. 3 by step 203.

In some embodiments the touch controller 101 can then output the touch parameters to a user interface controller 103.

In some embodiments the tactile display device comprises a user interface controller 103. The user interface controller 103 can be configured to receive the touch parameters (such as number of touch objects, shape of touch objects, position of touch objects, speed of touch objects) and furthermore a list of possible user interface objects which can be interfaced with or interacted with or can be associated with a suitable input parameter such as a touch parameter. The user interface controller 103 can then in some embodiments determine whether or not a user interface interaction has occurred with any of the user interface objects based on the touch parameters.

In some embodiments the user interface controller 103 can store or retrieve from a memory the list of possible user interface objects which can be interfaced with or interacted with or can be associated with a suitable input parameter such as a touch parameter.

In other words the user interface controller can have knowledge of a defined arbitrary two-dimensional or three-dimensional graphical user interface object which can be interacted with by the user or can be associated with a suitable input parameter such as a touch parameter. The arbitrary two-dimensional or three-dimensional graphical interface object can in some embodiments be associated with an image or similar which is to be displayed on the display (for example a shaded circle to simulate the appearance of a spherical graphical object). The arbitrary two-dimensional or three-dimensional graphical interface object can furthermore be associated or modelled by interaction parameters. These parameters define how the object interacts with the touch whether the object can be moved or is static, the ‘mass’ of the object (how much force is provided as feedback to the finger moving), the ‘buoyancy’ of the object (how much force is provided as feedback as the finger moves towards the screen), and the type interaction (for example is the object a switch, a button, a slider, a dial or otherwise with respect to interaction).

The operation of determining a user interface interaction based on the touch parameters is shown in FIG. 3 by step 205.

In some embodiments the user interface controller can be configured to output the results of the interaction to a suitable apparatus controller to control the apparatus. For example a graphical user interface interaction can cause an application to be launched or an option within an application to be selected.

The operation of controlling the apparatus is shown in FIG. 3 by step 207.

In some embodiments the tactile display device comprises a display user interface generator 105. The display user interface generator 105 can be configured to receive the output of the determination of whether there is a user interface interaction based on the touch parameters and the graphical user interface object and determine or generate display outputs based on the touch parameters and the user interface interaction to change the display.

Thus for example the display user interface generator 105 has knowledge of the two-dimensional or three-dimensional object being interacted with and based on the touch parameter generate a user interface display overlay which moves when the user interface controller indicates a suitable interaction.

The operation of generating a display output based on the touch parameters to change the display is shown in FIG. 3 by step 209.

In some embodiments the display user interface generator 105 can output this display information to a display driver 111.

In some embodiments the tactile display device comprises a display driver 111 configured to receive the display user interface generator 105 output and convert the display user interface generator image to suitable form to be output to the display 12.

The operation of outputting a change display to a user is shown in FIG. 3 by step 211.

In some embodiments the tactile display device comprises an ultrasound controller 107. The ultrasound controller 107 is configured to also receive the output of the user interface controller 103 and particularly with respect to determining whether a user interface interaction has occurred based on the touch parameters. Thus for example based on the knowledge of the graphical user interface two-dimensional or three-dimensional object and the touch parameters the ultrasound controller 107 can be configured to generate a suitable ultrasound ‘image’ which can be passed to the ultrasound drivers 109.

In some embodiments the example display device comprises at least one ultrasound driver 109 configured to receive the output from the ultrasound controller 107 and power the ultrasound actuators or transducers. In the example shown in FIG. 2 there is one ultrasound driver 109 for all of the ultrasound actuators but it would be understood that in some embodiments there can be other configurations, such as each ultrasound transducer or actuator being powered by a separate ultrasound driver.

The tactile display device can in some embodiments comprise at least one ultrasound actuator or transducer. As shown herein in FIG. 2 there can be a first actuator ultrasound actuator A 19a and a second actuator ultrasound actuator B 19b which can be configured to generate ultrasound pressure waves which can constructively or destructively combine to generate sound pressure at defined locations.

The operation of generating ultrasound in the direction of the touch parameters based on the user interface interaction is shown in FIG. 3 by step 213.

With respect to FIG. 4 an example tactile display device in operation is shown. FIG. 4 shows a top view of the device 10 comprising four ultrasound sources (or actuators or transducers) 19 located on the sides of the non-contact capacitive sensor 11 and display 12 on which the arbitrary 2-D or 3-D graphical user interface object 301 can be displayed.

Further as shown on FIG. 4 in the side view of the device 10 the virtual 2-D or 3-D graphical user interface object can be located above the device at a height such that the user hand (finger) or pointing device when interacting with the graphical user interface object 301 enables the ultrasound sources 19 to generate ultrasound pressure waves and thus generate a mapped and localised (using the non-contact capacitive sensory data) pressure field creating a sense of the virtual 2-D or 3-D object seen in the graphical user interface.

The pressure field is shown by the graphical user interface object representation 303 located above the device 10.

Furthermore with respect to FIG. 5 a further example user interface component is shown in the form of a slider displayed on the display. Furthermore with respect to FIG. 6 an example operation flow diagram with respect to the operation of the slider is shown.

In FIG. 5 a top view of the device 10 is shown with the ultrasound sources (actuators or transducers) 19 located on the sides of the display 12 incorporating the non-contact capacitive sensor 11. On the display is shown a slider image. The slider image comprises a slider track 401 along which a virtual slider ‘thumb’ or puck 403 can be moved. The track has a start 405 and end 407 boundary condition and also shows a linear segmentation shown by the segmentation borders 409. It would be understood that the user finger or hand or pointing device located over the position of the slider puck or ‘thumb’ image 403 can activate the slider control and a motion of the hand or pointing device up or down the slider track 401 can cause the interaction with the user interface object.

The slider shown in FIG. 5 is a linear slider however it would be understood that any suitable slider can be generated.

With respect to FIG. 6 the operation of the touch controller 101, UI controller 103 and ultrasound controller 107 in generating a tactile effect simulating the mechanical slider is described in further detail.

The touch controller 101 can be configured to determine a position of touch and furthermore the UI controller 103 is configured to determine the position of the touch is on the slider path representing the thumb position.

The operation of determining the position of touch on the slider path is shown in FIG. 6 by step 501.

The UI controller 103 can be configured to determine whether or not the touch or thumb position has reached one of the end positions.

The operation of determining whether not the touch or thumb has reached the end position is shown in FIG. 6 by step 503.

Where the touch has reached the end position then the UI controller 103 can be configured to pass an indicator to the ultrasound controller 107 so that the ultrasound sources 19 can be configured to generate a slider end position tactile feedback. The slider end position feedback can produce a haptic effect into the fingertip. In some embodiments is also audible and visually indicated by the display UI generator 105 showing the thumb or puck at the end of the track and allowing the user to know that the limit of the slider has been reached.

In some embodiments the slider feedback is dependent on which end position has been reached, in other words the slider feedback signal for one end position can differ from the slider feedback signal for another end position.

The generation of the slider end position feedback is show in FIG. 6 by step 505.

Where the touch or thumb has not reached the end position then the UI controller 103 can be configured to determine whether or not the touch or thumb has crossed a sector division.

The operation of determining whether the touch has crossed a sector division is show in FIG. 6 by step 507.

Where the touch has not crossed a sector division then the operation passes back to determining the position of touch on the slider path, in other words reverting back to the first step 501.

Where the touch has crossed the sector division then the UI controller 501 can be configured to pass an indicator to the ultrasound controller 107 to generate using the ultrasound sources 19 a slider sector transition feedback signal. The sector transition feedback signal can in some embodiments be different from the slider end position feedback signal. For example in some embodiments the sector transition feedback signal can be a shorter or sharper pressure pulse than the slider end position feedback. Similarly in some embodiments the slider sector transition can be experienced by an audio effect.

The operation of generating a slider sector feedback is shown in FIG. 6 by step 509. After generating the slider sector feedback the operation can then pass back to the first step of determining a further position of the touch or thumb on the slider path.

In some embodiments the slider can be a button slider in other words the slider is fixed in position until a sufficient downwards direction from the touch controller determination unlocks it from that position. In such embodiments the combination of the slider and mechanical button press tactile effect can be generated for simulating the effect of locking and unlocking the slider prior to and after moving the slider.

For example in some embodiments the UI controller 103 can determine the downwards motion required at which the slider thumb position is activated and permit the movement of the slider thumb only when a determined vertical displacement or ‘pressure’ is met or passed. In some embodiments the determined vertical displacement can be fixed or variable. For example movement between thumb positions between lower values can require a first vertical displacement and movement between thumb positions between higher values can require a second vertical displacement greater than the first to simulate an increased resistance as the slider thumb value is increased.

With respect to FIGS. 7 to 9 further example two-dimensional graphical user interface object interaction is shown. In some embodiments the object shown is a simulated isometric joystick or pointing stick. In such embodiments the touch controller, UI controller and ultrasound controller can thus operate to generate feedback which in some embodiments can be different for a first direction or dimension (x) and a second direction or dimension (y). Furthermore in some embodiments the touch controller and tactile feedback generator can be configured to generate feedback when simulating an isometric joystick based on the force that applied to the stick, where the force is the displacement or speed of motion of touch towards the first and second directions. The ultrasound controller in such embodiments could implement such feedback by generating feedback dependent on the speed or distance the finger is moved from the touch point (over the stick) after it has been pressed. Thus the feedback in such embodiments would get stronger the further away the finger is moved from the original touch point.

In some embodiments the touch controller and tactile feedback generator can be configured to generate tactile feedback for the isometric joystick simulating a button press. Furthermore in some embodiments the tactile feedback simulated isometric joystick can implement feedback for a latched or stay down button.

Furthermore it would be understood that in some embodiments the tactile feedback simulated isometric joystick can implement feedback similar to any of the feedback types such as knobs.

With respect to FIG. 7 a virtual two-dimensional joystick 601 is shown. The image 601 of the joystick has a vertical or three-dimensional component in terms of a height 603 above the display at which the joystick can be interacted with. In some embodiments the height 603 is the height at which the display comprising the noncontact capacitive sensor can detect a pointing device, hand or finger.

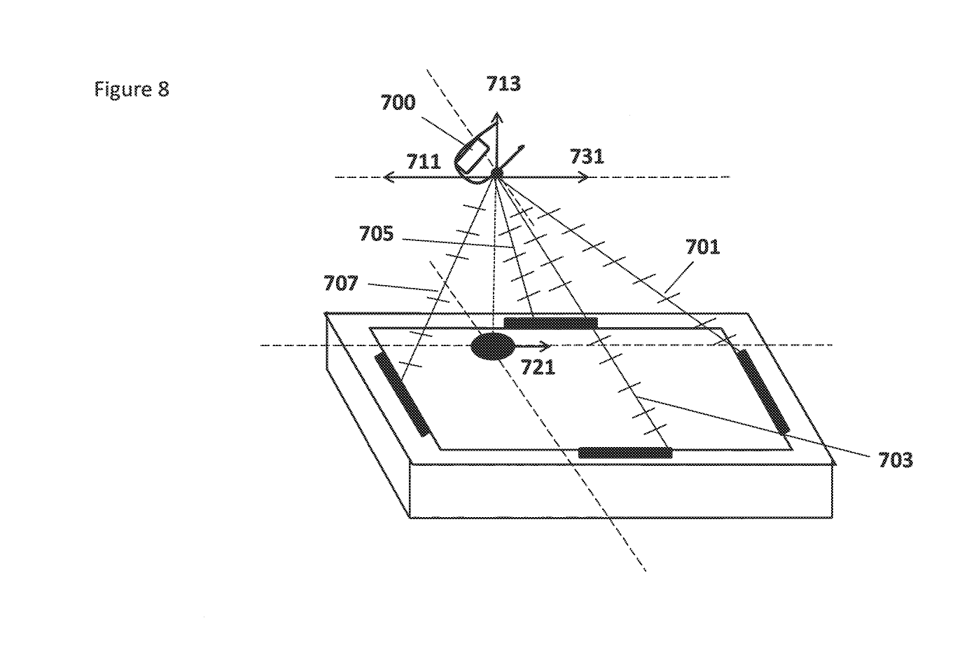

With respect to FIG. 8 an example operation of the tactile display device when a finger 700 is located above the two-dimensional graphical user interface object 601 at the height at which it can be detected is shown. The finger 700 is located such that the touch controller 101 determines a single touch point at a location and with a defined speed above the display. The direction of the finger movement is shown in FIG. 8 by the arrow 731. The touch controller 101 supplies the user interface controller 103 with the information of the touch position and speed. The user interface controller 103 can determine whether the touch position and speed is such that it interacts with the user interface object and the result of any such interaction. Thus in the example shown in FIG. 8 the motion and the position of the touch over the object can therefore cause the display user interface generator 105 to move the image of the object 601 in the direction shown by arrow 721 which is the same direction as the finger movement 731. Furthermore the UI controller 103 having determined an interaction between the finger and the user interface object can be configured to can pass information to the ultrasound controller 107 which generate an ultrasound display in the form of signals to the ultrasound drivers and the ultrasound actuators such that the ultrasound sources 19 generate acoustic waves 701, 703, 705, and 707 which produce a pressure wave experienced by the finger 700 in a direction opposite to the motion of the finger 731 and in the direction shown by arrow 711. In some embodiments the ultrasound controller 107 can generate an upwards pressure wave shown by arrow 713. In such embodiments therefore the finger experiences a resistance to the motion direction and a general reaction.

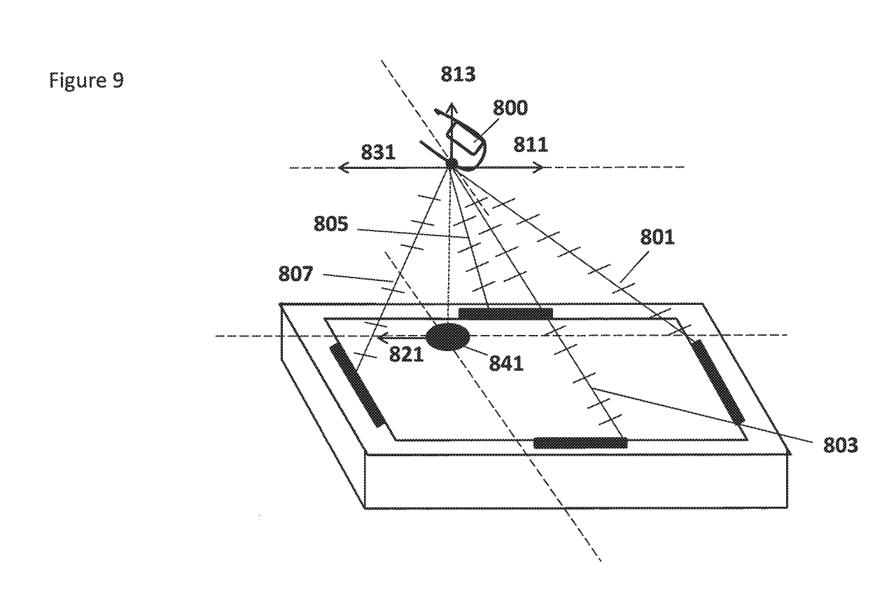

A similar approach is shown in FIG. 9 where the finger (or other suitable point object) 800 is detected by the touch input module 11 and the touch controller 101 determines the motion of the finger 800 in the direction shown by the arrow 831. The motion 831 of the finger 800 is passed to the user interface controller 103 which determines that there is an interaction between the motion of the finger and the user interface element 841. The interaction causes the display user interface generator 105 to move the graphical user interface object 841 in the direction 821 of the motion of the finger 831. Furthermore the interaction causes the ultrasonic controller 107 to generate via the ultrasonic driver and actuators 19 ultrasound pressure waves 801, 803, 805 and 807 such that the finger 800 experiences forces in the opposite direction 811 to the motion of the finger 831 and also in some embodiments upwards shown by arrow 813.

The user interface application and/or operating system can in some embodiments have conventional tactile events, such as simple tactile feedback from virtual tapping of alpha-numerical user interface elements or rendering and interaction of complex three dimensional virtual objects.

In some embodiments the non-contact capacitive input method can be combined with other sensory data, such as camera, to provide more accurate information on the user gestures and related information as described earlier.

Furthermore in some embodiments the ultrasound sources can be used to provide the ‘touch’ information to provide information of the user gestures and related information as described herein.

In some embodiments the ultrasound controller 107 can be configured to generate a continuous feedback signal whilst the object determined by the UI controller 103 is interacted with, in other words there can be a continuous feedback signal generated whilst an example button is active or operational.

In some embodiments a sequence or series of presses can produce different feedback signals. In other words the ultrasound controller 107 can be configured to generate separate feedback signals when determining that an example graphical user interface button press is a double click rather than two separate clicks.

Although the implementations as described herein can refer to simulated experiences of button clicks, sliders and knobs and dials it would be understood that the ultrasound controller 107 can be configured to produce tactile effects for simulated experiences based on the context or mode of operation of the apparatus.

Thus for example the ultrasound controller 107 can be configured to supply simulated mechanical button tactile effects during a drag and drop operation.

Although in the embodiments shown and described herein are single touch operations such as button, slider and dial it would be understood that the ultrasound controller 107 can be configured to generate tactile effects based on multi-touch inputs.

For example the tactile effect generator could be configured to determine feedback for a zooming operation where two or more fingers and the distance between the fingers define a zooming characteristic (and can have a first end point and second end point and sector divisions).

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the design of various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The design of embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory used in the design of embodiments of the application may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be designed by various components such as integrated circuit modules.

As used in this application, the term ‘circuitry’ refers to all of the following:
(a) hardware-only circuit implementations (such as implementations in only analog and/or digital circuitry) and
(b) to combinations of circuits and software (and/or firmware), such as:
   (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
determining at least one proximate object by at least one sensor;
determining at least one parameter associated with the at least one proximate object; and
generating using at least one ultrasound transducer at least one tactile effect to the determined at least one proximate object based on the at least one parameter.

2. The method as claimed in claim 1, further comprising:
determining at least one interactive user interface element;
determining the at least one parameter is associated with the at least one interactive user interface element; and
generating at least one tactile effect signal to be output to the at least one ultrasound transducer so to generate the tactile effect based on the at least one parameter being associated with the at least one interactive user interface element.

3. The method as claimed in claim 2, further comprising controlling the at least one ultrasound transducer to generate at least one ultrasound wave based on the at least one interactive user interface element and the at least one parameter.

4. The method as claimed in claim 1, wherein determining at least one proximate object by the at least one sensor comprises determining at least one proximate object by a display comprising the at least one sensor.

5. The method as claimed in claim 4, further comprising generating using the display at least one visual effect based on the at least one parameter.

6. The method as claimed in claim 1, wherein determining at least one parameter associated with the at least one proximate object comprises determining at least one of:
a number of the at least one proximate objects;
a location of the at least one proximate object;
a direction of the at least one proximate object;
a speed of the at least one proximate object;
an angle of the at least one proximate object; and
a duration of the at least one proximate object.

7. The method as claimed in claim 1, wherein generating using at least one ultrasound transducer at least one tactile effect to the determined at least one proximate object based on the at least one parameter comprises generating at least one of:
a tactile effect pressure wave envelope to the determined at least one proximate object based on the at least one parameter;
a tactile effect pressure wave amplitude to the determined at least one proximate object based on the at least one parameter;
a tactile effect pressure wave duration to the determined at least one proximate object based on the at least one parameter; and
a tactile effect pressure wave direction to the determined at least one proximate object based on the at least one parameter.

8. The method as claimed in claim 1, wherein determining the at least one proximate object by at least one sensor comprises at least one of:
determining the at least one proximate object by at least one capacitive sensor;
determining the at least one proximate object by at least one non-contact sensor;
determining the at least one proximate object by at least one imaging sensor;
determining the at least one proximate object by at least one hover sensor; and
determining the at least one proximate object by at least one fogale sensor.

9. The method as claimed in claim 1, wherein generating using at least one ultrasound transducer at least one tactile effect to the determined at least one proximate object based on the at least one parameter comprises controlling the at least one ultrasound transducer to generate at least one ultrasound wave based on the at least one parameter.

10. An apparatus comprising:
at least one sensor configured to determine at least one proximate object;
a parameter determiner configured to determine at least one parameter associated with the at least one proximate object; and
at least one ultrasound generator configured to generate at least one tactile effect to the determined at least one proximate object based on the at least one parameter.

11. The apparatus as claimed in claim 10, further comprising:
a user interface determiner configured to determine at least one user interface element;
at least one interaction determiner configured to determine the at least one parameter is associated with the at least one user interface element; and
a tactile effect generator configured to generate at least one tactile effect signal to be output to at least one ultrasound generator so to generate the tactile effect based on the at least one parameter being associated with the at least one interactive user interface element.

12. The apparatus as claimed in claim 10, further comprising:
an ultrasound transducer driver configured to control the at least one ultrasound generator to generate at least one ultrasound wave based on the at least one user interface element and the at least one parameter.

13. The apparatus as claimed in claim 10, wherein the at least one sensor may comprise a display configured to determine the at least one proximate object.

14. The apparatus as claimed in claim 10, further comprising a display user interface generator configured to generate on a display at least one visual effect based on the at least one parameter.

15. The apparatus as claimed in claim 10, wherein the parameter determiner configured to determine at least one of:
a number of the at least one proximate objects;
a location of the at least one proximate object;
a direction of the at least one proximate object;
a speed of the at least one proximate object;
an angle of the at least one proximate object; and
a duration of the at least one proximate object.

16. The apparatus as claimed in claim 10, wherein the ultrasound generator configured to generate at least one of:
a tactile effect pressure wave envelope to the determined at least one proximate object based on the at least one parameter;
a tactile effect pressure wave amplitude to the determined at least one proximate object based on the at least one parameter;
a tactile effect pressure wave duration to the determined at least one proximate object based on the at least one parameter; and
a tactile effect pressure wave direction to the determined at least one proximate object based on the at least one parameter.

17. The apparatus as claimed in claim 10, wherein the at least one sensor comprises at least one of:
at least one capacitive sensor;
at least one non-contact sensor;
at least one imaging sensor;
at least one hover sensor; and
at least one fogale sensor.

18. The apparatus as claimed in claim 10, wherein the ultrasound generator comprises an ultrasound controller configured to control at least one ultrasound transducer to generate at least one ultrasound wave based on the at least one parameter.

19. An apparatus comprising at least one processor and at least one memory including computer code for one or more programs, the at least one memory and the computer code configured to with the at least one processor cause the apparatus to at least:
determine at least one proximate object by at least one sensor;
determine at least one parameter associated with the at least one proximate object; and
generate using at least one ultrasound transducer at least one tactile effect to the determined at least one proximate object at the location of the at least one proximate object based on the at least one parameter.

20. The apparatus as claimed in claim 19, further caused to:
determine at least one interactive user interface element;
determine the at least one parameter is associated with the at least one interactive user interface element; and
generate at least one tactile effect signal to be output to the at least one ultrasound transducer so to generate the tactile effect.
